(19) United States
(12) Patent Application Publication
(10) Pub. No.: US 2012/0265107 A1
(43) Pub. Date: Oct. 18, 2012

(54) Therapeutic Treatment Device with EMG Biofeedback

(76) Inventor: Ruth Eileen Smith, Lamoni, IA (US)

(21) Appl. No.: 13/447,167

(22) Filed: Apr. 14, 2012

Related U.S. Application Data
(60) Provisional application No. 61/475,628, filed on Apr. 14, 2011.

(51) Int. Cl. A61H 7/00

(52) U.S. Cl. 601/15; 601/134

(57) ABSTRACT

A hand-held pressure applicator for treating painful muscle spasms, trigger points, or muscle tension in combination with an electromyographic (EMG) sensor and other possible add-ons, such as a means for applying laser therapy. Manual tactile pressure is applied through the hand-held applicator which is placed directly on the affected area overlaying the problematic muscle spasm or trigger point. Pressure sensors located at the tip of the applicator monitor the amount of tactile pressure administered to the patient. The applicator applies pressure to the affected area while simultaneously monitoring the muscular activity by way of EMG biofeedback. The applicator of the invention provides real time feedback that can be used to adjust the applied pressure, continue at the same level, or conclude the session.

### CROSS-REFERENCE TO RELATED APPLICATIONS

This application claims the benefit of priority from U.S. Provisional Patent Application Ser. No. 61/475,628 (filed 04-14-2011, i.e., Apr. 14, 2011). The entire content of Provisional Patent Application Ser. No. 61/475,628 is incorporated herein by reference in its entirety.

### STATEMENT REGARDING FEDERALLY SPONSORED RESEARCH OR DEVELOPMENT

Not Applicable.

### FIELD OF THE INVENTION

This invention relates to devices for treating musculoskeletal conditions. More specifically, the invention is indicated when portions of a muscle are sustaining excessive, involuntary tension or spasm.

### BACKGROUND OF THE INVENTION

Many healthcare professionals, such as physical therapists, chiropractors, and athletic trainers, treat musculoskeletal conditions and recognize the protective nature of contractile tissue when injury or overuse occurs. This protective mechanism, an involuntary contraction of surrounding muscle tissue, is essential for the immobilization effect during the early stages of healing. However, if the muscle fails to return to its normal muscle tone, the prolonged tension or spasm can delay healing of the injured area and induce the pain-spasm-pain cycle. For these reasons, it is common practice for these professionals to treat these muscle spasms in order to reestablish healthy circulation and reduce pain.

Although there are many treatment possibilities to reduce muscle spasm, one widely-practiced technique involves the application of tactile pressure over the affected spasm. The practitioner can either use their hands or part of their body, such as an elbow, to apply the pressure or use some sort of applicator, typically with a rounded but firm contact surface. The technique requires an effective amount of pressure over an effective amount of time in order for the tension in the muscle to be normalized. As the palpable tension decreases, additional pressure is applied for further relaxation of the tissue.

Because the above technique relies on the clinician's palpation skills, the process and final results are subjective, making it difficult to convince the medical field, third-party payers, and the general public of its validity and importance. The invention attempts to validate the technique by quantifying the tactile pressure applied by the clinician through pressure sensors along with the electrical activity of the muscle spasm through electromyography (EMG). Other features, such as laser therapy, may be added for additional therapeutic benefits.

Through objective application and measurement by the invention, the healthcare professional is more effective in their treatment of muscle spasms, thereby decreasing the healing time of many musculoskeletal injuries. Potentially, this increased efficiency not only results in improved treatment outcomes, but also reduced healthcare costs incurred by individuals and insurance companies.

A brief review of the prior art follows.

U.S. Pat. No. 5,666,964, which discloses muscle treating devices for use by muscular therapists and patients include a clamp device having utility as a muscle treating device. It includes a probe attached to a preselected movable jaw that simulates a therapist's fingers or thumb. It further includes a quick release device and a pressure measuring device so that a therapist can record pressures at which a patient reports discomfort. Additional muscle treating devices treat the cervical, thoracic, and lumbar regions of the back. Each of these devices includes a flat, rigid base and a support member disposed normal to the base having a groove formed in its peripheral edge for receiving neck vertebrae, the thoracic spine, and the lumbar spine, respectively. A combination device combines the cervical, thoracic, and lumbar devices into a single unit so that all of the muscles flanking the spinal column are treated simultaneously. Another device has an elongated inverted “V” structure and has utility for treating leg muscles, and still another device is a rigid or pivoting probe mounted in upstanding relation to a flat base and has utility in treating muscles of the lower back.

U.S. Pat. No. 6,267,738, which discloses a treatment tool and method for treating soft tissue by the application of pressure to muscles used in various therapeutic techniques such as trigger point, friction, effleurage and muscle stripping. In one embodiment, the invention comprises a massage tool having a shaft of a predetermined length and one or more ring members associated with the shaft member for providing muscle stripping and other therapy. The massage tool is of a weight sufficient to assist the therapist in delivering therapy. In another embodiment, the present invention comprises a paddle formed in one end of the shaft. In another embodiment, the massage tool of the present invention has a point member formed in a second end of the shaft for providing trigger point and other therapy.

U.S. Pat. No. 7,740,645 describes an apparatus and method for treating injured muscles before, during, and/or after physical activity. Practicing the method of the present involves pressing a plurality of pressure applicators against the skin proximate to a muscle for a sustained period of time. The pressure applicators pressed against the body can be either pins, support members, and/or any combination thereof. The support members may be secured to the therapeutic surface of a therapeutic body as to create an apparatus in accordance with the present invention. In such an apparatus, the base of pressure applicator is secured to the therapeutic surface such that the distal end of the pressure applicator extends away from the therapeutic surface.

U.S. Publication No. 2007/0270727 A1 describes a device for applying a non-invasive therapeutically reproducible pressure massage to skin and underlying tissues of the animal body. A Continuous Pressure Technique device and fitted attachable accessory components are provided for use with massage therapy on for a variety of target tissues of the patient body. Said accessory components include features allowing the induction of a therapeutically adequate profound pressure with relatively little effort enabling a therapist to treat a number of treatment targets, and a number of patients without excessive fatigue to the therapist. The provided CPT device provides for the capability of remotely determining pressure applied to the patient body simultaneously with use of the device.

None of the above inventions and patents, taken either singly or in combination, is seen to describe the instant invention as claimed.

### SUMMARY

A treatment device such as, but not limited to, a hand-held pressure applicator for treating painful muscle spasms, trigger points, or muscle tension in combination with an electromyographic (EMG) sensor and other possible add-ons, such as a means for applying laser therapy. Manual tactile pressure is applied through the hand-held applicator which is placed directly on the affected area overlaying the problematic muscle spasm or trigger point. Pressure sensors located at the tip of the applicator monitor the amount of tactile pressure administered to the patient. The applicator applies pressure to the affected area while simultaneously monitoring the muscular activity by way of EMG biofeedback. The applicator of the invention provides real time feedback that can be used to adjust the applied pressure, continue at the same level, or conclude the session. For example, if applicator reduces muscular tension in the spasm or trigger point, the EMG detects this change in muscular activity and the clinician is assured that the applied pressure is appropriate and effective. However, if tension is not measurably reduced the EMG will also indicate these results so that appropriate pressure adjustments to the applicator can be made.

### BRIEF DESCRIPTION OF THE DRAWINGS

FIG. 1 shows a schematic of a treatment device according to the invention.

FIG. 2 shows an end view of the tip of a pressure applicator according to the invention.

FIG. 3 shows a schematic of a treatment device according to the invention.

FIG. 4 is listing of parts represented in Table 1.

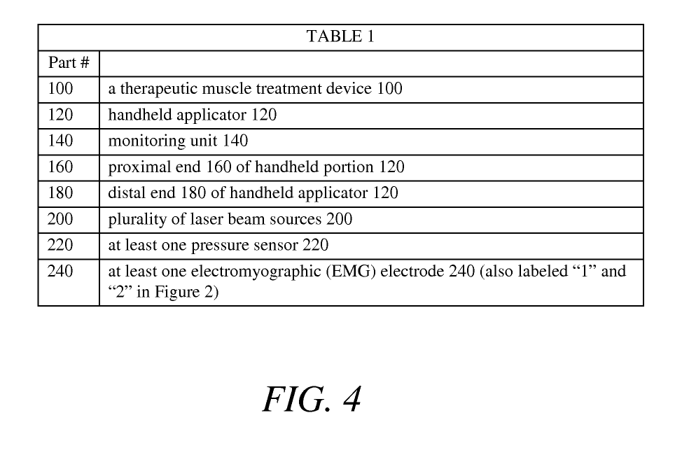

Similar reference characters denote corresponding features consistently throughout the attached drawings.

### DETAILED DESCRIPTION OF THE PREFERRED EMBODIMENTS

This invention is directed to devices for treating such conditions as musculoskeletal, neurological and soft tissue conditions and relieving such conditions as muscle tension and/or pain. More specifically, the invention is a hand-held pressure applicator for treating painful muscle spasms, trigger points, or muscle tension in combination with an electromyographic (EMG) sensor, and other optional add-ons such as, but not limited to, a plurality of laser diodes to apply laser therapy to soft tissue in need of such therapy. The terms “apparatus” and “device” are hereinafter regarded as equivalent terms. Table 1 lists part numbers.

The description and Figures presented herein demonstrate that the present invention may be practiced or implemented in a variety of embodiments. The discussion of these embodiments amounts to a complete written description that enables those of ordinary skill in the art to make and use the invention. While several embodiments are expressly disclosed herein, it should be appreciated that the present invention is not limited to the specifically disclosed embodiments. Indeed, the structures, features, operations or functions of the described may be reorganized or reconfigured to create one or more structural or functional equivalent embodiments of the invention that are not specifically discussed herein, but nevertheless fall within the scope of the present invention.

Further, for purposes of description herein, while such terms as “upper,” “lower,” “right,” “left,” “rear,” “front,” “vertical,” “horizontal,” and derivatives thereof are used herein to assist the reader, it should be understood that the invention may assume various orientations and step sequences, except where expressly specified to the contrary. All the U.S. Patent Numbers mentioned in this disclosure together with U.S. Pat. No. 6,244,010 are incorporated herein by reference in their entirety.

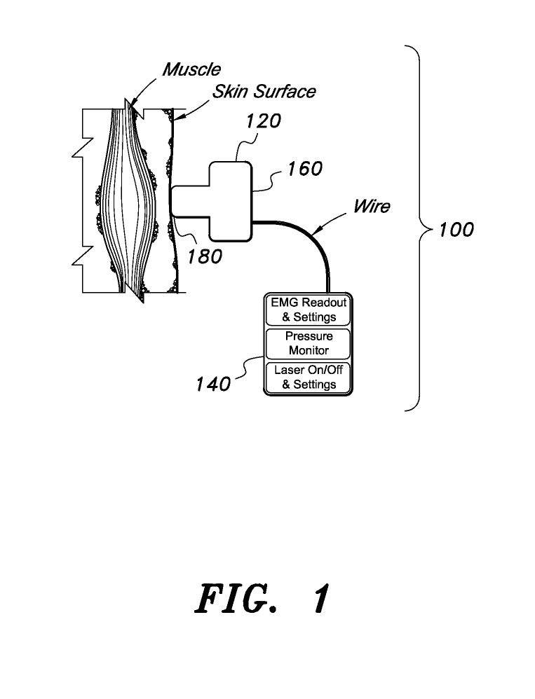

FIG. 1 is a schematic illustration of a therapeutic muscle treatment device 100 according to one embodiment of the invention. The device 100 includes a handheld applicator 120 coupled to a monitoring unit 140. Handheld applicator 120 defines a proximal end 160 and a distal end 180 thereof. During normal use the proximal end 160 is typically held by a therapist or other medical professional, and the distal end 180 is pressed against an appropriate area of a patient's body requiring therapy. A plurality of laser beam sources 200 are mounted in distal end 180. The laser beam sources 200 can be made up, for example, of laser diodes. The laser energy from laser beam sources 200 have a wavelength of about 630 nm to about 904 nm. Treatment times, total dosage, and number of treatment points on the patient's body are determined by the therapist trained in delivering such therapy.

The laser beam sources 200 can be angled so that laser beams emitted from the laser beam sources 200 intersect a short distance away from the distal end 180 thus producing a combined power output proportional to the number and power of each laser beam sources 200. For example, if five 30 mW laser diodes make up the plurality of laser sources 200 and are angled so that the laser output intersects a short distance away from the distal end 180, the combined power output is 150 mW at the point of intersection. The area of the point of intersection can be, for example, 2 cm² (2 square centimeters). The area of intersection can have any overall shape such as a circular shape.

The specific laser diodes chosen depends on the desired wavelength of the emitted laser energy, which depends on a number of factors including cost, as well as the desired level of penetration, and the type of tissue and injury being treated. In addition, some wavelengths appear to be especially suitable for specific applications. For example, the laser sources 200 can be made up of low power HeNe lasers emitting at a relatively short wavelength of about 633 nm; such laser sources are especially suited for conditions or injuries requiring lower levels of penetration, such as skin wounds, mucous membranes problems, and eye conditions such as conjunctivitis. However, for most internal tissue injuries amenable to therapy using device 100, a penetration depth of about 2-3 cm is suitable, and is achieved with an intermediate wavelength of about 830 nm emitted, for example, by laser sources 200 made up of GaAlAs laser diodes. In addition to wavelength, the precise number and type of diodes used can be varied, limited only by the requirement that the combined or total mean power output be in the range of about 100 mW to about 500 mW, in pulsed or continuous mode.

In one embodiment the laser sources 200 comprise of GaAIAs diodes emitting at a near-infrared wavelength of about 830 nm in a collimated beam. 30 mW GaAIAs diodes are relatively inexpensive, easily commercially obtained, and collectively provide a mean power output in the range of about 100 mW to about 500 mW. However, higher or lower power GaAIAs diodes, or other biostimulative diodes emitting in the visible to near-infrared wavelength range of about 630 nm to about 904 may be used. For example, in one alternative embodiment, InGaAIP laser diodes are used, emitting at a wavelength of about 630-685 nm. In another alternative embodiment, pulsed GaAs diodes are used, emitting at about 904 nm. In other alternative embodiments, the combined or total power output is varied from about 100 mW about 500 mW by changing the number and power of diodes used.

The various parameters for the laser function, such as the wavelength, power output, and treatment dosage, are manually set by the clinician. These settings are located on the monitoring unit 140.

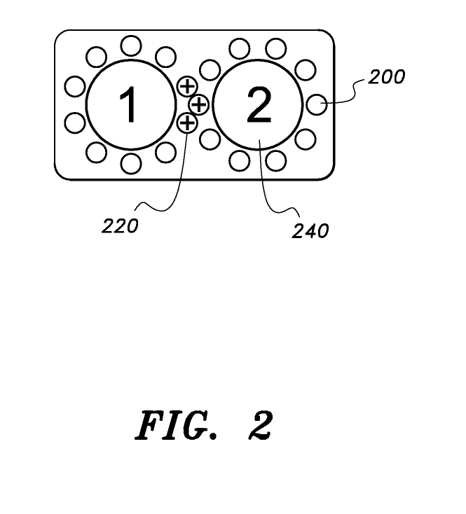

Referring to FIG. 2, the distal end 180 is further comprised of at least one pressure sensor 220 and at least one electromyographic (EMG) electrode 240. The EMG electrodes 240 are appropriately positioned on the distal end 180 in order to provide biofeedback to the clinician by detecting and monitoring the muscular tension underneath the applicator 120.

The visual and/or auditory biofeedback feature is located on the monitoring unit 140 which is connected to the applicator by a lead wire(s). The clinician applies the pressure applicator 120 to the skin overlying an area to be treated with the applicator 120. If the biofeedback from the monitoring unit 140 indicates tension reduction, then the clinician is reassured that the applied pressure is effective. In this case, the same amount of pressure is continued until the muscular tension is no longer detected. However, if the monitoring unit 140 indicates that the muscular tension is unchanged or increasing, the clinician knows to alter the amount of pressure until a reduction of muscular tension is detected. Again, once an effective amount of pressure is determined, the clinician would maintain that same pressure until the muscular tension was undetectable. In order for the EMG electrodes 240 to effectively sensor the muscular tension, the monitoring unit 140 would also include the electronic circuitry to adjust the sensitivity of the electrodes 240 as well as provide the visual and/or auditory biofeedback.

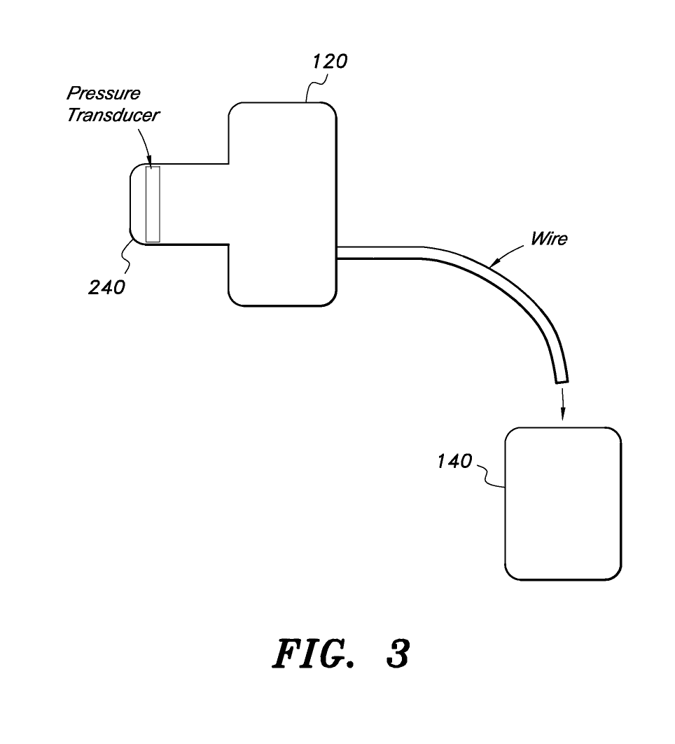

The at least one pressure sensor 220 can be a pressure transducer which, optionally, can be placed immediately behind the EMG electrode 240 (see FIG. 3) such that pressure applied to the EMG electrode 240 during contact with a patient's skin also registers on the pressure sensor. The pressure sensor detects the amount of applied pressure which can be displayed on the monitoring unit 140.

It should be understood that the apparatus of the invention can be used by anyone conversant with medical equipment use that need not be a clinician per se, but can be a nurse, a physiotherapist, a medical doctor, a medical technician or anyone with experience or competency in the use of medical equipment.

It is to be understood that the present invention is not limited to the embodiments described above, but encompasses any and all embodiments within the scope of the following claims.

What is claimed:

1. A treatment device for treating a patient in need of muscle or tissue therapy, comprising:
a means for detecting tactile pressure; and
a means for monitoring muscular activity to provide output in the form of electromyographic (EMG) biofeedback,
wherein an operator of said treatment device enables an operator to manually adjust the amount of tactile pressure to be applied to a patient's body in response to output from said means for providing EMG biofeedback.

2. The treatment device according to claim 1 further comprising a plurality of laser sources to provide laser therapy.

3. The treatment device according to claim 2, wherein said plurality of laser sources is made up of laser diodes.
